(19) United States
(12) Patent Application Publication
(10) Pub. No.: US 2016/0216859 A1
(43) Pub. Date: Jul. 28, 2016

(54) CREATING A LIST OF ITEMS FROM SELECTIONS OF CONTENT WITHIN AN E-BOOK

(71) Applicant: Kobo Incorporated, Toronto (CA)

(72) Inventor: Sarah FLAWN, Toronto (CA)

(73) Assignee: Kobo Incorporated, Toronto (CA)

(21) Appl. No.: 14/604,085

(22) Filed: Jan. 23, 2015

(51) Int. Cl. G06F 3/0483; G06F 3/0481; G06F 3/0482

(52) U.S. Cl. CPC G06F 3/0483; G06F 3/0482; G06F 3/04817

(57) ABSTRACT

Methods and systems for creating a list of items from selections of content within an e-Book are provided. A portion of content of an e-Book presented on the e-reading device is selected. The portion of content is imported into a designated list category. A user accessible list interface is provided for each designated list category.

### TECHNICAL FIELD

Examples described herein relate to creating a list of items from selections of content within an e-Book.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®), and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reading device) devices typically link to an online bookstore, and media playback devices often include applications that enable the user to access an online median electronic library (or e-Library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-Book services on an e-reading device, according to an embodiment.

FIG. 2 illustrates an example architecture configuration of an e-reading device, according to an embodiment.

FIG. 3A illustrates an e-reading device creating a list of items from a selection of content within an e-Book, according to an embodiment.

FIG. 3B illustrates an e-reading device creating a list of items from a different selection of content within an e-Book, according to an embodiment.

FIG. 3C illustrates an e-reading device creating a list of items from yet another selection of content within an e-Book, according to an embodiment.

FIG. 3D illustrates an e-reading device displaying the list of items produced from selections of content within an e-Book, according to an embodiment.

FIG. 4 illustrates a method for creating a list of items from selections of content within an e-Book, according to an embodiment.

### DETAILED DESCRIPTION

Methods and systems for creating a list of items from selections of content within an e-Book are disclosed. For example, a user can create and organize lists of grocery items and other products electronically clipped from a variety of source e-books such as, but not limited to, cookbooks, magazines, style guides, and the like. In one embodiment, the lists of items are stored in a folder in the user's e-library on the user's e-reading device. The information can be used for planning and organizing meals, events, home improvement projects, and the like. The lists will be based on varied content sourced from the user's e-library collection, and, as such, will be accessible to the user whenever the e-reading device is at hand.

In general, “E-Books” are a form of electronic publication content stored in digital format in a computer non-transitory memory, viewable on a computing device having display functionality. An e-Book can correspond to, or mimic, the paginated format of a printed publication for viewing, such as provided by printed literary works (e.g., novels) and periodicals (e.g., magazines, comic books, journals, etc.). Optionally, some e-Books may have chapter designations, as well as content that corresponds to graphics or images (e.g., such as in the case of magazines or comic books).

Multi-function devices, such as cellular-telephony or messaging devices, can utilize specialized applications (e.g., specialized e-reading application software) to view e-Books in a format that mimics the paginated printed publication. Still further, some devices (sometimes labeled as “e-reading devices”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-Book. By way of example, an e-reading device can include a mobile computing device on which an e-reading application can be executed to render content that includes e-Books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reading device, such as a purpose-built device that is optimized for an e-reading experience (e.g., with E-ink displays).

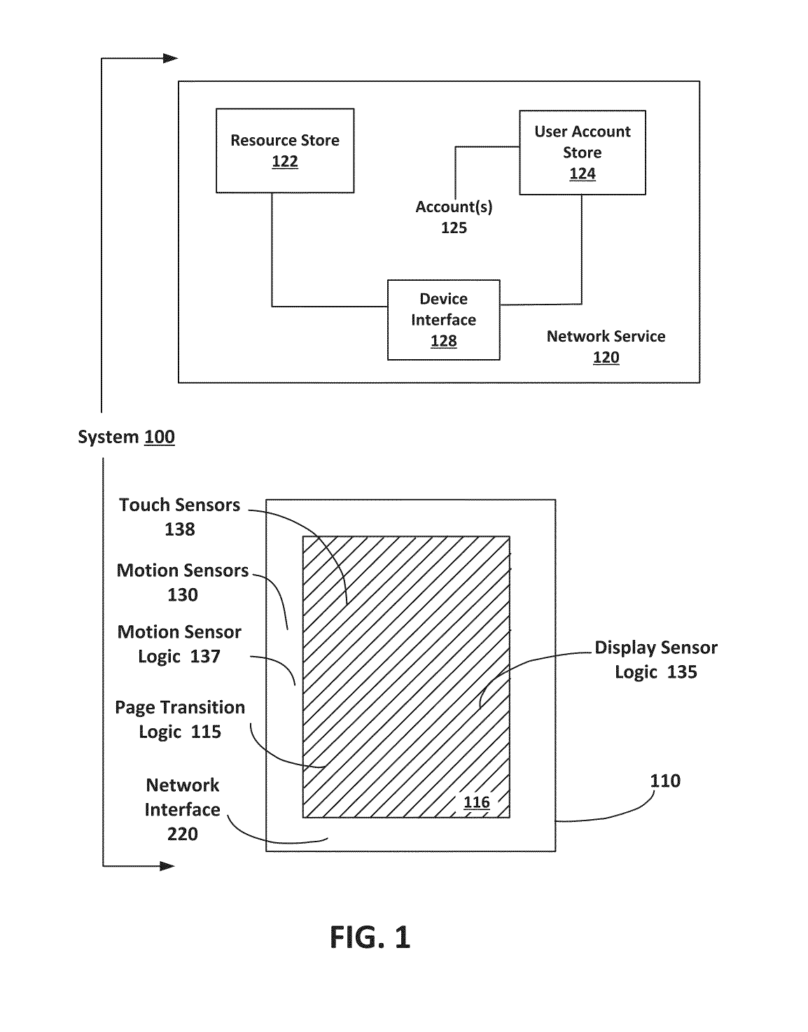

FIG. 1 illustrates a system 100 for utilizing applications and providing e-Book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the c-reading device 110. By way of example, in one implementation, the network service 120 can provide e-Book services that communicate with the e-reading device 110. The e-Book services provided through network service 120 can, for example, include services in which e-Books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-Books, media files, documents) can be rendered and consumed. For example, the e-reading device 110 can correspond to a tablet or telephony/messaging device (e.g., smart phone). In one implementation, for example, e-reading device 110 can run an e-reading device application that links the device to the network service 120 and enables e-Books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-Books). For example, the c-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-Books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-Books and content items are associated with the user device. Additionally, the device interface 128 can provide the e-reading device 110 with access to the resource store 122, which can include, for example, an online store. The device interface 128 can handle input to identify content items (e.g., e-Books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-Books) that are purchased or otherwise made available to the user of the e-reading device 110, as well as to archive e-Books and other digital content items that have been purchased for the user account 125, but are not stored on the particular computing device.

With reference to an example of FIG. 1, e-reading device 110 can include a display 116 and an optional housing, not shown. In an embodiment, the display 116 is touch-sensitive, to process touch inputs including gestures (e.g., swipes). For example, the display 116 may be integrated with one or more touch sensors 138 to provide a touch-sensing region on a surface of the display 116. For some embodiments, the one or more touch sensors 138 may include capacitive sensors that can sense or detect a human body's capacitance as input. In the example of FIG. 1, the touch sensing region coincides with a substantial surface area, if not all, of the display 116. Additionally, the housing can be integrated with touch sensors to provide one or more touch sensing regions, for example, on the bezel and/or back surface of the housing.

e-reading device 110 can also optionally include one or more motion sensors 130 arranged to detect motion imparted thereto, such as by a user while reading or in accessing associated functionality. In general, the motion sensor(s) 130 may be selected from one or more of a number of motion recognition sensors, such as but not limited to, an accelerometer, a magnetometer, a gyroscope and a camera. Further still, motion sensor 130 may incorporate or apply some combination of the latter motion recognition sensors.

e-reading device 110 further includes motion sensor logic 137 to interpret user input motions as commands based on detection of the input motions by motion sensor(s) 130. For example, input motions performed on e-reading device 110 such as a tilt, a shake, a rotation, a swivel or partial rotation and an inversion may be detected via motion sensors 130 and interpreted as respective commands by motion sensor logic 137.

In some embodiments, the e-reading device 110 includes features for providing functionality related to displaying paginated content. The e-reading device 110 can include page transitioning logic 115, which enables the user to transition through paginated content. The e-reading device 110 can display pages from e-Books, and enable the user to transition from one page state to another. In particular, an e-Book can provide content that is rendered sequentially in pages, and the c-Book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state In the specific example embodiment where a given page state coincides with a single page, for instance, each page state corresponding to one page of the digitally constructed series of pages paginated to comprise, in one embodiment, an e-Book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state.

For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116. Although discussed in context of “taps” herein, it is contemplated that a gesture action provided in sufficient proximity to touch sensors of display 116, without physically touching thereon, may also register as a “contact” with display 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display 116, otherwise known as a touch event. More specifically, display sensor logic 135 can detect a touch events also referred to herein as a tap, an initial tap held in contact with display 116 for longer than some pre-defined threshold duration of time (otherwise known as a “long press” or a “long touch”), multiple taps performed either sequentially or generally simultaneously, swiping gesture actions made through user interaction with the touch sensing region of the display 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

The term “sustained touch” is also used herein and refers to a touch event that is held in sustained contact with display 116, during which sustained contact period the user or observer may take additional input actions, including gestures, on display 116 contemporaneously with the sustained contact. Thus a long touch is distinguishable from a sustained touch, in that the former only requires a touch event to be held for some pre-defined threshold duration of time, upon expiration of which an associated input command may be automatically triggered.

In one implementation, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display 116 for the purpose of associating respective input commands therewith.

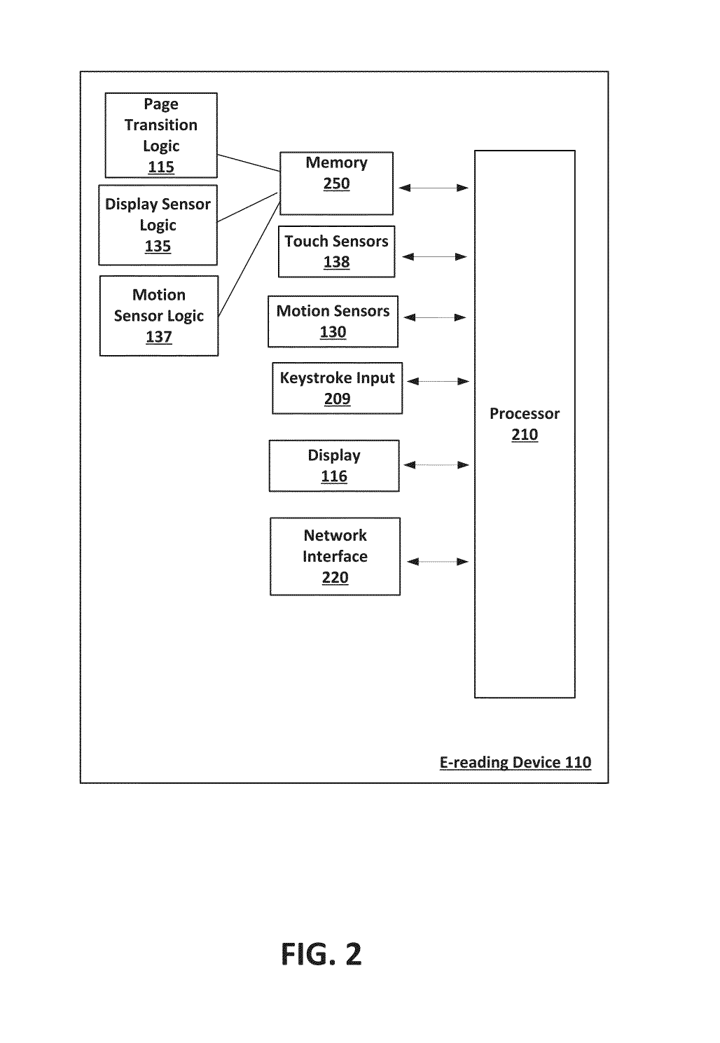

FIG. 2 illustrates further detail of e-reading device 110 as described above with respect to FIG. 1, in an embodiment. e-reading device 110 further includes processor 210, a memory 250 storing instructions and logic pertaining at least to display sensor logic 135, and page transition logic 115.

Processor 210 can implement functionality using the logic and instructions stored in memory 250. Additionally, in some implementations, processor 210 utilizes the network interface 220 to communicate with the network service 120 (see FIG. 1). More specifically, the e-reading device 110 can access the network service 120 to receive various kinds of resources (e.g., digital content items such as e-Books, configuration files, account information), as well as to provide information (e.g., user account information, service requests etc.). For example, e-reading device 110 can receive application resources, such as c-Books or media files, that the user elects to purchase or otherwise download via the network service 120. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can optionally receive input from various sources, including touch sensor components 138, display 116, keystroke input 209 such as from a virtual or rendered keyboard, and other input mechanisms (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-Book activities such as generating c-Book content on display 116, performing page transitions of the displayed e-Book content, powering off the e-reading device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

In one embodiment, network interface 220 of e-reading device 110 includes wireless connectivity subsystems, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of the wireless connectivity subsystem of network interface 220 depends on the communication network in which e-reading device 110 is intended to operate, such as in accordance with Wi-Fi, Bluetooth, Near Field Communication (NFC) communication protocols, and the like.

Display 116 of e-reading device 110 includes touch functionality whereby user input commands may be accomplished via gesture actions performed at display 116. In the context of reading digitally rendered pages comprising content of an e-Book, for example, some common input commands accomplished via gesture actions received at display 116 may include, for example, page turns, making annotations, adjusting illumination levels or contrast of the device display screen, and re-sizing the font size of text in the content.

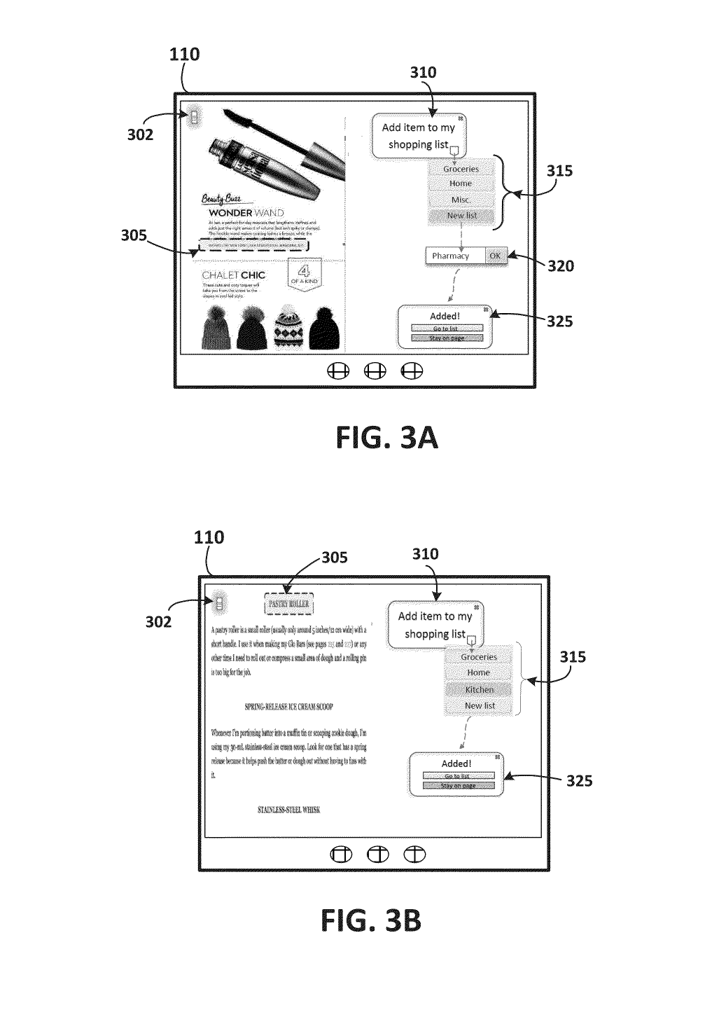

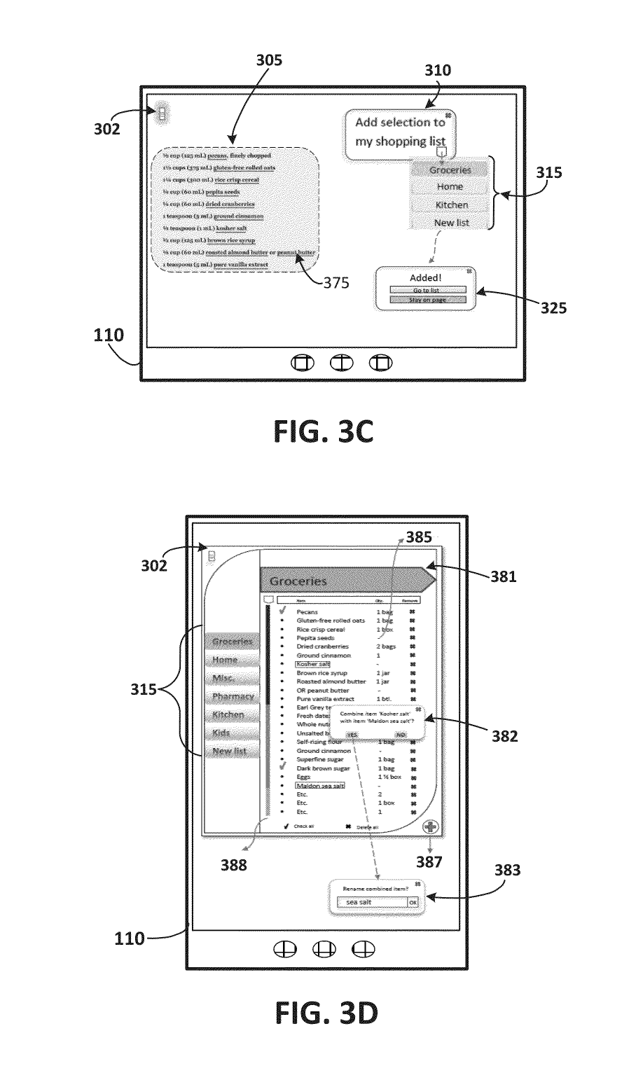

With reference now to FIG. 3A, a diagram of an c-reading device 110 creating a list of items from a selection of content within an e-Book is shown according to an embodiment. In one embodiment, an e-magazine such as a beauty magazine is shown. However, it should be appreciated that in each of FIGS. 3A-3D the e-book and selections thereof may be from any type of e-content, such as, but not limited to, a cooking magazine, a recipe book, a style magazine, a home improvement magazine, a newspaper, or any type of e-book. The type of material shown herein is provided merely for purposes of clarity.

In one embodiment, FIG. 3A includes a user selectable list icon 302, a selection of e-content 305, a list selector 310, and a drop-down lists menu 315. List icon 302 activates or enables the underlying functionality for creating a list of items from selections of content within an e-Book on an e-reading device 110. Selection of e-content 305 indicates a portion of content of the e-book that has been chosen by a user to be added to one of the lists in list menu 315 of list selector 310. In FIG. 3A, the selected content is placed in a custom list 320. In the present example, the custom list is labeled pharmacy since the selected portion relates to a beauty product. Pop-up 325 informs the user that the item or items have been successfully added to a list. In one embodiment, pop-up 325 offers the user a chance to stay on the page or to proceed to the list. In another embodiment, pop-up 325 may inform the user that the item was not successfully added to a list.

Referring now to FIG. 3B, a diagram of an e-reading device 110 creating a list of items from a different selection of content within an e-Book is shown according to an embodiment. In one embodiment, FIG. 3B includes previously described list icon 302, selection of e-content 305, list selector 310, lists menu 315 and pop-up 325. However, in contrast to FIG. 3A, FIG. 3B shows a tool, e.g., a pastry roller, being the selected item. As such, the pastry roller is determined to fit within a predefined list category of kitchen.

With reference now to FIG. 3C, a diagram of an e-reading device 110 creating a list of items from yet another selection of content within an e-Book is shown according to an embodiment. In one embodiment, FIG. 3C includes previously described list icon 302, selection of e-content 305, list selector 310, lists menu 315 and pop-up 325. However, FIG. 3C illustrates a selection of e-content 305 that includes an entire recipe. In one embodiment, specific grocery items within the selected recipe are recognized via digitizing the content portion selected. In addition, one embodiment extracts only relevant items in creation of the shopping list, such as quantity, brands, qualifying words, and the like. An example of the generated shopping list that includes the extracted relevant items is shown and described in FIG. 3D.

In addition, portions of the recipe include alternates 375. That is, items that may be used in place of one another instead of needing to have both. For example, either a cup of roasted almond butter or a cup of peanut butter is called for in the recipe. This alternate would be designated as such in the shopping list so that a user would not unnecessarily purchase both.

Referring now to FIG. 3D, a diagram of an e-reading device 110 displaying the list of items 381 produced from selections of content within an e-Book is shown according to an embodiment. In one embodiment, FIG. 3D includes previously described list icon 302, and lists menu 315. In addition, FIG. 3D shows the list of items 381, in the present example it is the groceries list. In addition to showing the grocery list of items 381, in one embodiment, a quantity 385 is linked with each appropriate item.

In one embodiment, a pop-up indicating a potential double entry 382 is shown. In one embodiment, potential double entry 382 draws a user's attention to a possible repetitive entry and allows a user the option to elect to combine 383 list items. In one embodiment, FIG. 3D also includes an add new item 387 selector as well as a source indicator 388. In one embodiment, source indicator 388 is an identifier for a source of the portion of content imported into the designated list category, such as a color-coding indicator or a link to identify the source e-book from which the portion of content was obtained. For example, items on the grocery list that are ingredients obtained from a desert e-book may be coded with a certain color, number or the like; while items that are ingredients obtained from a dinner e-book would be coded with a different color, number or the like.

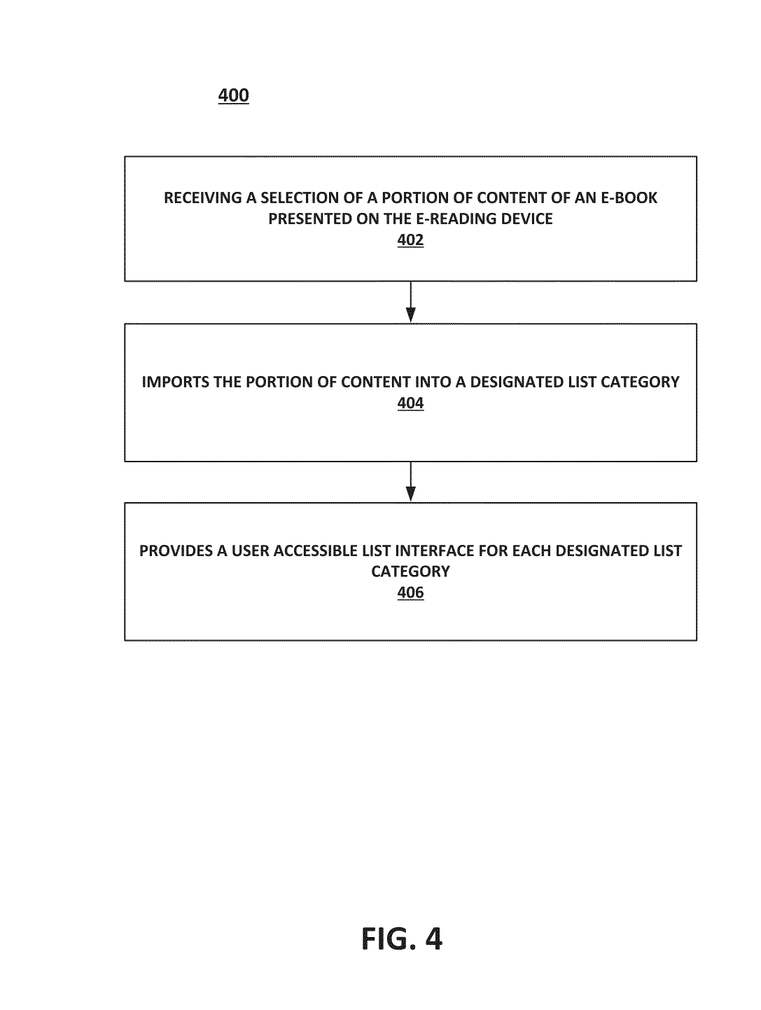

With reference now to FIG. 4, a method for creating a list of items from selections of content within an e-Book is shown according to an embodiment. For example, a user can create and organize lists of grocery items and other products electronically clipped from a variety of source e-books such as, but not limited to, cookbooks, magazines, style guides, and the like. The lists of items are stored in a folder in their e-library on their e-reading device. The information can be used for planning and organizing meals, events, home improvement projects, and the like. The lists will be based on varied content sourced from the user's e-library collection, and, as such, will be accessible to the user whenever the e-reading device is at hand.

Referring now to 402 of FIG. 4 and to FIGS. 3A-3C, one embodiment receives a selection of a portion of content of an e-Book presented on the e-reading device 110. In one embodiment, the list feature discussed herein is enabled by a list icon 302 that is user selectable. Selecting list icon 302 activates the creating of the list of items from selections of content within the e-Book. That is, once the list feature is enabled, a selection is made by a user highlighting, or otherwise indicating a portion of the e-book content. For example, the portion of content may be grocery items from e-magazine and e-cookbook recipes, make-up, tools, and other products selected from an e-magazine and the like.

With reference now to 404 of FIG. 4 and to FIGS. 3A-3C, one embodiment imports the portion of content into a designated list category. For example, in one embodiment there is a number of default designated list categories, such as, but not limited to, groceries, home improvement, mall, and the like. In another embodiment, there is a customized list categories, such as, but not limited to, Sarah's winter wardrobe, pharmacy, and the like.

One embodiment, automatically selects the designated list category for the importing of the selected portion from a plurality of list categories. For example, the selected content is digitized and identification information is automatically extracted and used to determine which designated list category should receive the selected portion.

In addition, one embodiment recognizes a number of distinct items from within the portion of content, parses the number of distinct items into a number of separate items, and imports the number of separate items into a designated list category 315. For example, one embodiment recognizes specific grocery items within the selected text, via digitizing the content portion selected, and extracting only relevant items in creation of the shopping list, such as by recognizing certain qualifying words and/or popular brands i.e. ‘whole’, ‘dried, ‘gluten-free’, ‘Maldon’, etc. In addition, a quantity associated with one or more of the number of separate items, e.g., grocery items, is determined and the quantity 385 is linked with each appropriate item.

Referring now to 406 of FIG. 4 and to FIG. 3D, one embodiment provides a user accessible list interface 381 for each designated list category 315. In one embodiment, potential double entry 382 may be detected in the shopping list, whereupon users can elect to combine 383 list items. For example, Kosher salt and Maldon salt can be combined in list under ‘flakey salt’. Moreover, the list may provide source indicator 388, such as, a color-coding indicator or other type of identifier, a link, and the like, to identify the source e-book from which the portion of content was obtained.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method for creating a list of items from selections of content within an e-Book on an e-reading device, the method executed in a processor of an e-reading device comprising: a display, and a memory for storing instructions, the method comprising:
receiving a selection of a portion of content of an e-Book presented on the e-reading device;
importing the portion of content into a designated list category; and
providing a user accessible list interface for each designated list category.

2. The method of claim 1 further comprising:
providing a user selectable list icon on a display of said e-reading device, said list icon activating the creating of the list of items from selections of content within the e-Book.

3. The method of claim 1 further comprising:
automatically selecting the designated list category for the importing of the selected portion from a plurality of list categories.

4. The method of claim 1 further comprising:
generating a customized list category;
manually selecting the customized list category as the designated list category for the importing of the selected portion from a drop down menu comprising a plurality of list categories; and
importing the selected portion into the customized list category.

5. The method of claim 1 further comprising:
recognizing a number of distinct items from within the portion of content;
parsing the number of distinct items into a number of separate items; and
importing the number of separate items into a designated list category.

6. The method of claim 5 further comprising:
determining a quantity associated with one or more of the number of separate items; and
linking the quantity with each appropriate separate item.

7. The method of claim 1 further comprising:
detecting a double entry on the list of the designated list category; and
providing a user selectable pop-up for drawing attention to the double entry.

8. The method of claim 1 further comprising:
providing an identifier for a source of the portion of content imported into the designated list category; and
linking the identifier with the portion of content.

9. An e-reading device comprising:
a memory that stores a set of instructions and an e-book having digital content therein;
a touch screen display;
a user selectable list icon on the display of said e-reading device, said list icon when selected enables a creation of a list of items from selections of content within the e-Book presented on the e-reading device; and
a processor that accesses the instructions in memory, the processor configured to:
receives a selection of a portion of content of an e-Book presented on the e-reading device;
import the portion of content into a designated list category selected from a plurality of list categories; and
provide a user accessible list interface for each designated list category.

10. The e-reading device of claim 9 further comprising:
a customized list category.

11. The e-reading device of claim 9 wherein the processer:
automatically recognizes a number of distinct items from within the portion of content;
parses the number of distinct items into a number of separate items; and
imports the number of separate items into the designated list category.

12. The e-reading device of claim 11 wherein the processer:
automatically determines a quantity associated with one or more of the number of separate items; and
links the quantity with each appropriate separate item.

13. The e-reading device of claim 11 wherein the processer:
automatically detects a double entry on the list of the designated list category; and
provides a user selectable pop-up to draw attention to the double entry.

14. The e-reading device of claim 11 wherein the processer:
provides an identifier for a source of the portion of content imported into the designated list category; and
links the identifier with the portion of content.

15. A computer-readable medium that stores instructions and an e-book for an e-reading device, the e-reading device including a processor, a touch screen displays, and a memory storing instructions and a digital content item, the instructions being executable by the processor to cause the e-reading device to perform a method for creating a list of items from selections of content within an e-Book comprising:
providing a user selectable list icon on a display of said e-reading device, said list icon activating the creating of the list of items from selections of content within the e-Book;
receiving a selection of a portion of content of an e-Book presented on the e-reading device;
importing the portion of content into a designated list category; and
providing a user accessible list interface for each designated list category.

16. The computer-readable medium of claim 15 further comprising:
automatically selecting the designated list category for the importing of the selected portion from a plurality of list categories.

17. The computer-readable medium of claim 15 further comprising:
generating a customized list category;
manually selecting the customized list category as the designated list category for the importing of the selected portion from a drop down menu comprising a plurality of list categories; and
importing the selected portion of content into the customized list category.

18. The computer-readable medium of claim 15 further comprising:
automatically recognizing a number of distinct items from within the portion of content;
parsing the number of distinct items into a number of separate items; and
importing the number of separate items into a designated list category.

19. The computer-readable medium of claim 18 further comprising:
automatically determining a quantity associated with one or more of the number of separate items; and
linking the quantity with the separate item.

20. The computer-readable medium of claim 15 further comprising:
automatically detecting a repetitive entry on the list of the designated list category; and
providing a user selectable pop-up for drawing attention to the repetitive entry.

21. The computer-readable medium of claim 15 further comprising:
providing an identifier of the e-book from which the portion of content was selected; and
linking the identifier with the portion of content.
